(19) United States
(12) Patent Application Publication
(10) Pub. No.: US 2025/0367578 A1
(43) Pub. Date: Dec. 4, 2025

(54) Method and Apparatus for Cleaning Filter Media

(71) Applicant: Veolia Water Solutions & Technologies Support, Saint-Maurice (FR)

(72) Inventor: Oscar Velastegui, Corona, CA (US)

(21) Appl. No.: 18/876,291

(22) PCT Filed: Jun. 28, 2023
(86) PCT No.: PCT/US2023/026395

§ 371 Date: Dec. 18, 2024

Related U.S. Application Data
(60) Provisional application No. 63/357,063, filed on Jun. 30, 2022.

(51) Int. Cl. B01D 24/46; B01D 24/14

(52) U.S. Cl. CPC B01D 24/4684; B01D 24/14; B01D 2201/081

(57) ABSTRACT

System and process for cleaning media in a vessel includes directing a cleaning liquid into the vessel. A fluidizing pump draws the cleaning liquid from the vessel and returns a portion of the cleaning liquid to a fluidizing nozzle that is directed downwardly into the vessel. The fluidizing nozzle discharges the cleaning liquid in a jet stream that contacts the media causing the media to move upwardly in the vessel and become fluidized. The media is continuously fluidized and agitated for a time. In the process, contaminants associated with the media are separated and become contained in the cleaning liquid. During this process, most of the media is confined while within the vessel.

### FIELD OF THE INVENTION

The present invention relates to filters, such as nutshell filters, for filtering wastewater.

### BACKGROUND OF THE INVENTION

Media filters, such as nutshell filters, are used to remove contaminants from fluids. They have many applications. For example, nutshell filters are used in the oil and gas industries to remove oil, suspended solids and other contaminants from produced water. Nutshells, such as walnut and pecan nutshells, remove oil by coalescing it in between media particles. Over time, the nutshell media becomes clogged or partially clogged with suspended solids, crude oil coatings and other contaminants. This reduces the efficiency of the nutshell filter and from time-to-time, the nutshell media must be cleaned.

Many nutshell filters utilize an internal or external scrubber containing a scrubber screen to clean the nutshell media. Nutshell media is transferred from a vessel that forms a part of the nutshell filter to an outside scrubber that, as noted above, includes a cleaning screen. In the cleaning process, the nutshell media passes through the scrubber and is returned to the vessel. In practice, the nutshell media is continuously circulated for a period of time back and forth between the vessel and the scrubber.

There are numerous drawbacks and disadvantages to nutshell filters that rely on internal or external scrubbers. During start-up, the scrubber screen typically becomes fouled with media fines. This requires cleaning multiple times in a week or month. After start-up, the scrubber screen stills require periodic cleaning.

Even though the scrubber screen is outside the filter vessel, it is difficult and time consuming to remove and clean. Prior to cleaning, the scrubber screen has to be isolated or locked-out from the filter vessel. Scrubber screens are typically large and heavy and are disposed at a height that often requires a mobile crane in order to facilitate removal. Moreover, cleaning these screens is a recurring and non-trivial maintenance task for the operator.

Furthermore, in some filter designs, the pump and motor that circulates the media during cleaning is mounted atop the vessel so as to self-drain media accumulated during the cleaning cycle. This requires maintenance personnel to perform maintenance on the pump and motor atop the vessel. If the pump or motor needs replacing, then this can also require a crane. In addition, many of the top mounted pumps are belt-driven due to the pump mounting structure and the need to adjust RPM. Some operators require a horizontal direct coupled ANSI or API pump which makes the design complicated and costly. In addition, the filters having top mounted pumps and motors require an upper platform and a ladder to access the pump and motor. The size of these platforms has increased over time to meet regulatory requirements. In the end, these high profile vessels that employ a top platform and top mounted motors and pumps significantly increase the overall cost of the filter.

In the application of nutshell filters, the site might have several nutshell filters in operation. The overall design of these filters requires a dedicated pump for each filter for pumping the media through the scrubber. Yet, the pumps employed for cleaning are only periodically used. Hence, substantial cost can be eliminated by providing a media filter design where a single pump used for media cleaning could serve multiple filters.

### SUMMARY OF THE INVENTION

The present invention entails a media filter design that eliminates the internal or external media scrubber and includes a system and process where the media is cleaned within the vessel of the filter.

In one embodiment, cleaning the media entails directing a cleaning liquid into the vessel. A fluidizing pump draws the cleaning liquid from the vessel and returns at least a portion of the cleaning liquid to a fluidizing nozzle that is directed downwardly into the vessel. The fluidizing nozzle discharges the cleaning liquid downwardly in a jet stream that contacts the media in the vessel, causing the media to move upwardly through the vessel and become fluidized in the vessel. The media is continuously fluidized and agitated for a selected time period in the vessel. In the process, contaminants associated with the media are separated therefrom and become contained in the cleaning liquid. During this cleaning process, most of the media is confined within the vessel such that the cleaning process is carried out in the vessel and without the media exiting the vessel and entering a scrubber external to the vessel or passing through a scrub screen internal to the vessel. During the media cleaning phase, a portion of the cleaning liquid bypasses the fluidizing nozzle and is discharged.

During the cleaning phase, a small amount of the media can escape the vessel and become entrained in the cleaning liquid that bypasses the fluidizing nozzle. Prior to discharge, the cleaning liquid passes through a media collector that collects the media entrained in the cleaning liquid. After completing the media cleaning phase, the fluidizing pump is employed to direct cleaning liquid from the vessel, through the media collector where the cleaning liquid collects the media and thereafter the cleaning liquid and collected media are returned to the vessel via the fluidizing nozzle.

Another aspect of the present invention entails a media filter design wherein the fluidizing pump used for cleaning the media is configured within the overall filter design such that it can be used to fluidize the media in multiple vessels, thereby obviating the necessity of all of the filters having a media fluidizing pump.

The above discussion pertains particularly to cleaning the media. Prior to cleaning the media, the media filter is used to filter a liquid such as, for example, produced water. It has been discovered that the media during startup tends to be quite buoyant. To address this problem, it is preferable prior to starting the service phase to hydrate the media for a selected time period. This will tend to reduce the buoyancy of the media during the filtration phase, enhance the efficiency of the media and prevents media from leaving the vessel in large quantities.

Other objects and advantages of the present invention will become apparent from a study of the following description and the accompanying drawings which are illustrative of the invention.

### BRIEF DESCRIPTION OF THE DRAWINGS

FIG. 1 is a schematic illustration of the media filter of the present invention illustrating the piping network and flow controls that are incorporated for controlling the flow of liquid through the media filter during filtering, media cleaning and media retrieval.

FIG. 2 is a schematic illustration similar to FIG. 1 but illustrating the flow of liquid in heavy dashed lines during the filtering phase.

FIG. 3 is a view similar to FIG. 1 but showing the flow of liquid in heavy dashed lines through the system during the media cleaning phase.

FIG. 4 is a view similar to FIG. 3 but showing the flow of liquid in heavy dashed lines during the media retrieval phase.

FIGS. 5A and 5B show a media collector in the form of a hydrocyclone that is used to collect media during the media cleaning phase.

FIGS. 6A and 6B are schematic illustrations of a double screen assembly that can be used as a media collector during the media cleaning phase.

FIGS. 7A and 7B are schematic illustrations of a modified Y strainer that can be used as media collector during the media cleaning phase.

FIG. 8 is a schematic illustration showing how a single fluidizing pump associated with a media filter can be utilized to fluidize the media in one or more other vessels.

### DESCRIPTION OF EXEMPLARY EMBODIMENTS OF THE PRESENT INVENTION

Media filters are known. See, for example, the media filters described in U.S. Pat. No. 5,635,080 (the '080 patent) and U.S. Pat. No. 8,828,237 (the '237 patent), the disclosures of which are expressly incorporated herein by reference. Various types of media can be employed in a media filter. One media type is nutshells, such as walnut or pecan shells. There are other types of media used in various filtering applications. As discussed in the '080 and '237 patents, the media filter includes a vessel loaded with media. Influent or the liquid to be treated is directed into an upper portion of the vessel. From there, the influent passes downwardly through the media. In this process, contaminants, such as suspended solids and oil, are captured, coalesced or adsorbed onto the media. This produces a filtrate at the bottom of the vessel. The filtrate is discharged from the bottom of the vessel. Over time, the media will become clogged or partially clogged with suspended solids and other contaminants removed from the influent during filtering. When this happens, the efficiency of the media filter is impaired and as discussed above, the media must be cleaned. The discussion that follows focuses on an efficient cleaning process for cleaning the media. First, the aim of the present invention is to perform the cleaning operation while substantially all or most of the media remains in the vessel. This eliminates the need for an external scrubber used by some media filters. Also, the inventor, through testing, realizes that in fluidizing and cleaning the media, it is difficult to retain all of the media in the vessel. That is, even though the overall design aims to confine the media within the vessel during cleaning, it is likely that a small amount of media will escape the vessel. Hence, one of the features of the media filter design described here involves a system and process that collects the escaping media outside the vessel and returns the media back to the vessel. This is one of the advantages of the media filter of the present invention. Current media filter designs suffer from media loss and the operator or customer is required to add media from time to time. This will not occur with the media filter described here as all of the media (other than normal media attrition) escaping the vessel, is captured and sent back to the vessel.

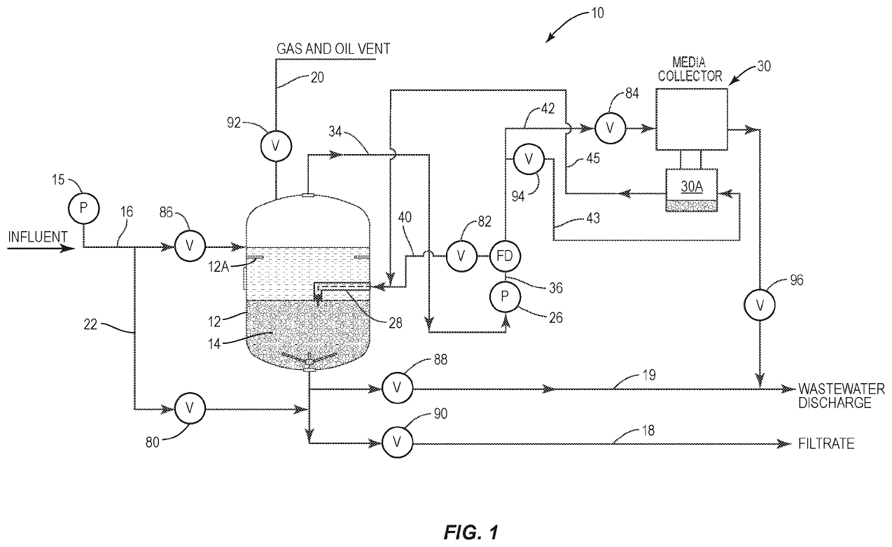

Turning to the drawings, FIG. 1 is a schematic illustration of a media filter, indicated generally by the numeral 10, and its basic components along with a piping network. Media filter 10 includes a vessel 12 designed to hold media 14. An inlet line 16 extends into an upper portion of the vessel 12 and functions to channel the influent (liquid to be filtered) into the vessel 14. A feed pump 15, typically provided by the end user, pumps the influent into inlet line 16. Once in the vessel 12, the influent passes downwardly through the media 14 towards the bottom of the vessel. In the process, contaminants, such as suspended solids and oil, are captured or adsorbed onto the media 14. This produces a filtrate that is directed into a distributor stationed in the bottom of the vessel. The filtrate is discharged from the vessel 12 into a filtrate discharge line 18.

Before discussing the media cleaning system and process, it is noted that the media filter 10 includes means for venting gas and oil from the upper portion of vessel 12. Prior to cleaning the media and periodically during service, oil and gas should be vented from the vessel. As illustrated in FIG. 1, a vent line 20 enables gas and oil that collects in the upper portion of the vessel 12 to be vented. The oil and gas are ultimately directed to a discharge point.

Media filter 10 includes a backwash feed line 22. Line 22 (during media cleaning) directs feed water into a lower portion of the vessel 12. As will be discussed subsequently, during the media cleaning process, cleaning liquid is continuously supplied to the vessel 12. The term “cleaning liquid” as used herein in a broad term that includes any liquid stream that is used to clean the media (including the backwash and recirculation flow) or to retrieve the media from a media collector to be described subsequently. In the embodiments illustrated in the drawings, the source of the cleaning liquid is the liquid stream being treated. However, the source of the cleaning liquid could be a dedicated cleaning liquid source or any other liquid stream that is convenient to the media filter.

Media filter 10 includes a fluidizing pump 26. Fluidizing pump 26 can be located at various locations relative to the vessel 12. In particular, the design of the media filter 10 does not require the fluidizing pump 26 to be located atop the vessel 12 or any particular place for that matter. It can be conveniently located in various places and as described later, a single fluidizing pump 26 can be utilized by a number of media filters 10 without requiring each media filter to include its own dedicated fluidizing pump.

Media filter 10 includes a fluidizing nozzle 28 disposed interiorly within the vessel 12. Note in the drawings where the fluidizing nozzle 28 is located at an intermediate height within the vessel 12 and is directed downwardly towards the underlying media 14.

Media filter 10 also includes a media collector 30 disposed exteriorly of the vessel 12. Media collector 30 is designed to intercept and collect media entrained in the cleaning liquid during the media cleaning phase. As discussed later, media collector 30 is designed to allow the cleaning liquid to pass through it and at the same time to cause the media entrained in the cleaning liquid to be directed to a collection area 30A in the media collector. Furthermore, media collector 30 is designed such that, after media cleaning, a liquid stream, such as the cleaning liquid, can be directed through the media collector 30 and through the collection area to retrieve the collected media and return it to the vessel 12.

Media filter 10 includes a piping or conduit network that is integrated with the vessel 12, fluidizing pump 26, fluidizing nozzle 28 and media collector 30. The piping network includes piping, valves and various other flow control elements for controlling and directing the flow of the influent or cleaning liquid through the media filter system. See FIG. 1.

Viewing the piping network, line 34 is connected to the top of the vessel 12 and extends therefrom to the low pressure side of the fluidizing pump 26. Line 36 extends from the high pressure side of the fluidizing pump 26 to a flow divider FD. Flow divider FD in the media cleaning phase divides the flow of the cleaning liquid passing in line 36 such that a portion of the flow in line 36 is directed into line 40 that leads to the fluidizing nozzle 28 and another portion is directed into line 42 which leads to the media collector 30. Line 42 continues through the media collector 30 to a discharge point that is termed in the drawings as “wastewater discharge”.

During the media cleaning, cleaning liquid is pumped into line 22 and through a backwash inlet into the vessel 12. While cleaning liquid is being supplied to the vessel 12, the fluidizing pump 26 generates suction at the top of the vessel which causes the fluid in the vessel to move upwardly through an outlet in the top of the vessel into line 34. Cleaning liquid in line 34 travels through the fluidizing pump 26 into line 36. From line 36, the cleaning liquid splits (via the flow divider FD) with a first portion of the cleaning liquid being directed to the fluidizing nozzle 28 via line 40 and while a second portion of the cleaning liquid is directed into line 42. The flow divider referred to above is typically a pipe tee incorporated into the piping. In normal operation, the flow in line 42 is equal to the flow in line 22 because valve 80 is generally 100% open. Valve 96 is a modulating control valve that controls the flow in lines 22 and 42. In any event, the cleaning liquid flowing through line 40 is discharged downwardly by the fluidizing nozzle 28. The discharge of the cleaning liquid is in the form of a high pressure jet stream that is directed downwardly towards the underlying media. This causes the media to move upwardly into the upper portion of the vessel 12 which effectively fluidizes the media. This is a continuous process where fluidization agitates the media and separates the suspended solids and other contaminants from the media, such that the contaminants are now contained in the cleaning liquid. While the media is being cleaned in the vessel 12 through this fluidization process, the smaller cleaning liquid stream in line 42 passes through the media collector 30 and is discharged from the system.

As seen in the drawings, the piping network includes numerous valves that control the flow of liquid during certain phases of operation. During media cleaning, valves 80, 82, 84 and 96 are open. The remaining valves, valves 86, 88, 90, 92 and 94 are closed. This enables the cleaning liquid to be pumped from the vessel 12 through the fluidizing pump 26 and to the fluidizing nozzle 28 and media collector 30.

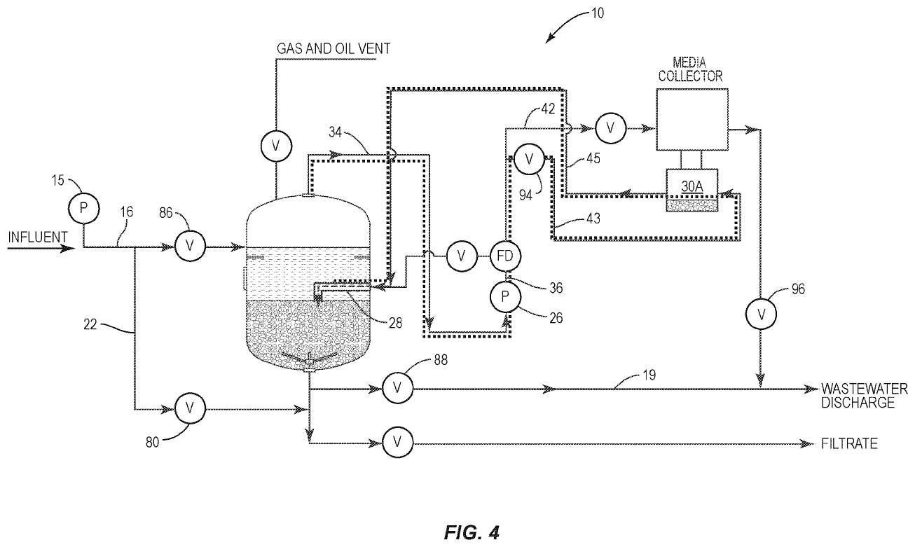

During media retrieval, valve 94 is open and the remaining valves are closed. As seen in FIG. 4, backwash is pumped from vessel 12 through line 34 and the fluidizing pump 26 into line 43. Since valve 94 is open, the cleaning liquid can pass through the media collection chamber 30A of the media collector 30. As the cleaning liquid passes through the media collection chamber 30A, it picks up media and the cleaning liquid and the collected media enter line 45, which returns the cleaning liquid and the collected media to the vessel 12 via the fluidizing nozzle 28. This part of the process is rather brief since only a relatively small amount of media collected in chamber 30A is required to be returned to the vessel 12.

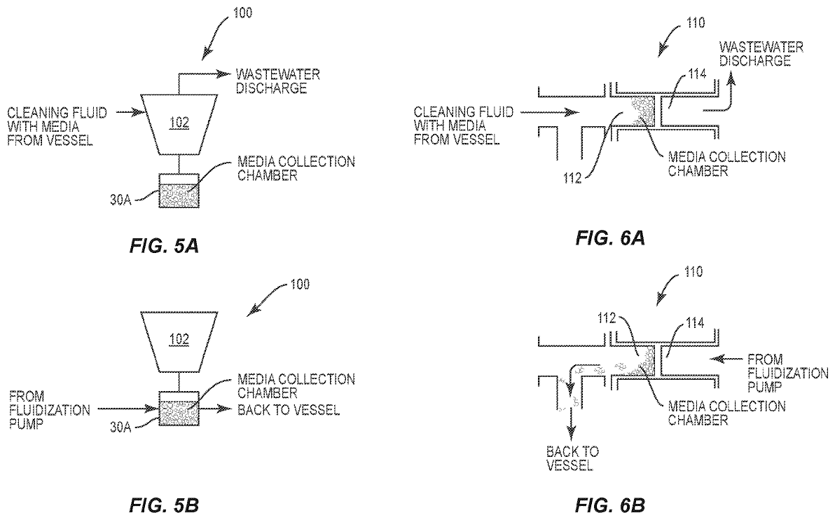

Media collector 30 can assume various forms. Three examples of media collectors are shown in FIGS. 5A-7B. FIGS. 5A and 5B schematically show a hydrocyclone that is indicated generally by the numeral 100. Hydrocyclone 100 includes an upper section 102 and a lower section 30A which forms a media collection chamber. FIG. 5A shows the flow of cleaning liquid through the hydrocyclone during the media cleaning phase. This simply includes directing the cleaning liquid containing some media into the upper section 102 which essentially separates the media from the cleaning liquid. The separated media falls into the lower section or media collection chamber 30A and the cleaning liquid exits the upper section 102 and is referred to in FIG. 5A as “wastewater”. FIG. 5B shows the hydrocyclone when the media in the media collection chamber 30A is being retrieved. Here again, cleaning liquid from the fluidizing pump 26 is directed through the lower section or media collection chamber 30A where the cleaning liquid picks up the collected media and returns it to vessel 12.

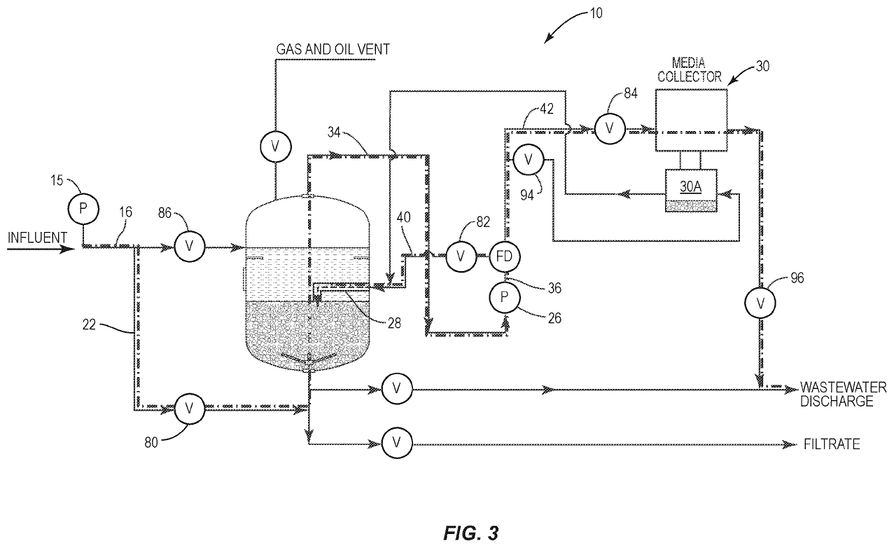

FIGS. 6A and 6B show a double screen assembly 110 which can be used as a media collector in the system described above. The double screen assembly 110 includes two aligned screens 112 and 114. During media cleaning, cleaning liquid carrying some media is directed into screen 112 and as the cleaning liquid flows through this screen, media is collected therein. Once the media is separated from the cleaning liquid, the cleaning liquid continues through the second screen 114 and exits the same as “wastewater”. See FIG. 6A. Once the media cleaning phase is complete, the flow of cleaning liquid through the double screen assembly 110 is generally reversed. To retrieve the media collected in screen 112, cleaning liquid from the fluidizing pump is directed first through the second screen 114 and then through the first screen 112 where the cleaning liquid picks up the collected media and directs it out a side outlet and back to the vessel 12. It is appreciated that the double screen assembly 110 can easily be incorporated into the system design shown in FIGS. 1-4. It is further appreciated that a number of valves would be required to control the flow through the double screen assembly 110 in order to collect the media during the media cleaning phase and to retrieve the media during the media retrieval phase.

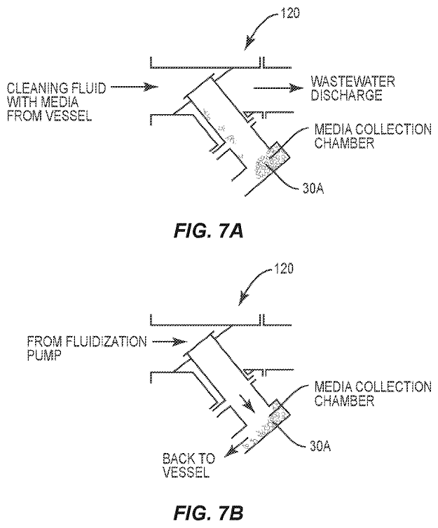

Another form of a media collector 30 is shown in FIGS. 7A and 7B. It is referred to as modified Y strainer and is indicated generally by the numeral 120. A strainer is set at an angle with respect to an inlet line and an outlet line. During the media cleaning phase, cleaning liquid enters through the inlet line and passes through the strainer to the outlet line. In the process, the modified Y strainer collects the media entrained in the backwash and causes the media to be captured and to fall down into a media collection chamber 30A that forms a part of the strainer. Once the cleaning phase has been completed, the media collected in the media collection chamber 30A is retrieved by directing the cleaning liquid into the inlet line and through the strainer and through the media collection chamber 30A where the cleaning liquid picks up the media. The cleaning liquid is then directed out an outlet adjacent the media collection chamber 30A and returned to the vessel 12 via the fluidizing nozzle 28. Again, it will be appreciated that a number of valves would be associated with the modified Y strainer assembly in order to selectively direct the flow of cleaning liquid during the media cleaning phase and the media retrieval phase.

Media filter 10 is designed to retain the media in the vessel 12 during cleaning. As an option, to facilitate the retention of the media, vessel 12 is provided with a baffle structure 12A disposed in the upper portion of the vessel. Note in FIG. 1 where the baffle structure 12A is disposed above the fluidizing nozzle 28 and just below the top of the vessel. Hence during the fluidization of the media, the media tends to move upwardly along the sides of the vessel 12 where the baffle structure 12A will engage or contact the media and retard the upward movement of at least some of the media.

It might be beneficial to briefly review the basic sequences or phases that normally take place in the operation of the media filter 10. Prior to startup, it is beneficial to hydrate the media for a selected period of time. The time can vary for the hydration but in one example, the media is hydrated for approximately 24 hours. This tends to reduce the buoyancy of the media and can have a positive effect on the amount of media recirculation.

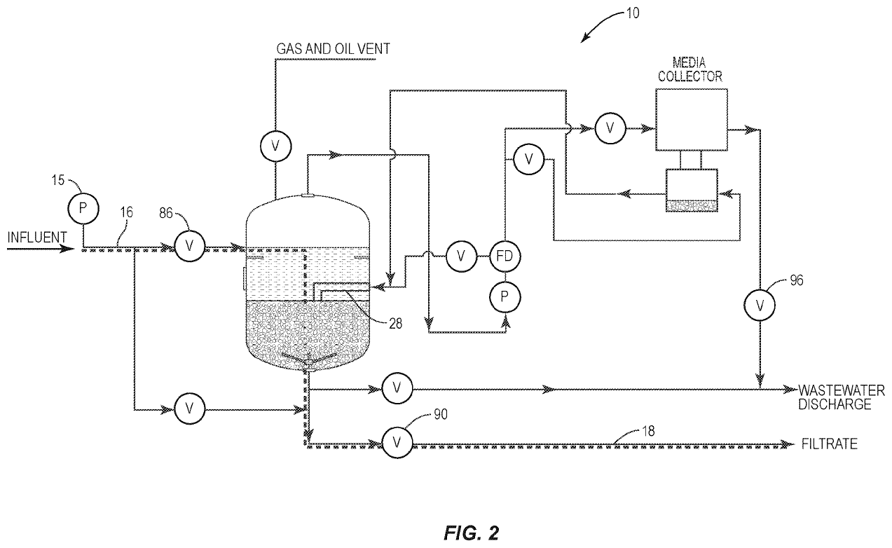

In service, the influent or liquid to be filtered is directed into an upper portion of the vessel 12. See FIG. 2. From there the influent passes downwardly through the media, resulting in suspended solids and other contaminants being removed from the influent. A filtrate is produced at the bottom of the vessel and is discharged via line 18 therefrom. Periodically during the service phase and before media cleaning, gas and oil that accumulate in the upper portion of the vessel 12 are vented from the vessel via vent line 20. The duration of the media cleaning can vary, but in one example the duration of the media cleaning is approximately 10 to approximately 20 minutes. After media cleaning, the media retrieval phase discussed above is initiated. This, as described above, entails circulating cleaning liquid from the vessel through the media collector 30 to retrieve media collected during the media cleaning operation. This phase is relatively brief and besides retrieving the media from the media collector, this phase of operation also agitates and cleans the media in the vessel 12. After collecting the media from the media collector 30, a typical operation of the media filter 10 provides a period for the media to settle. After settling, it is preferable that the media be thoroughly rinsed before returning to the service phase using line 19.

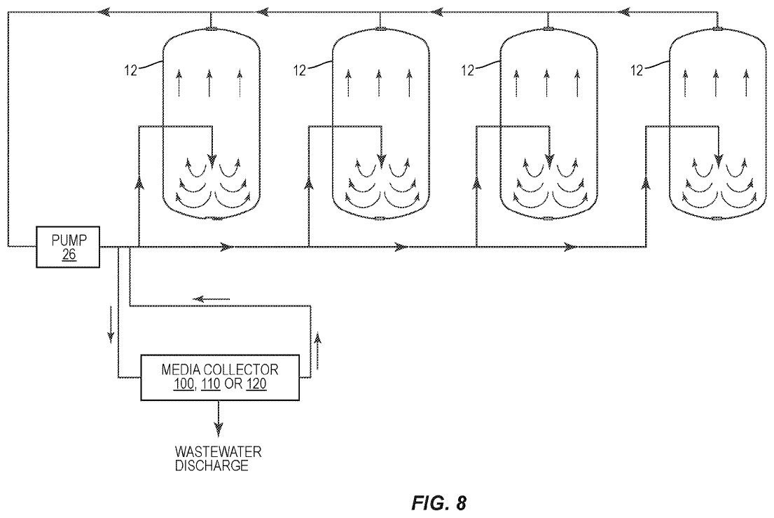

As discussed earlier, one particular advantage of the media filter 10 is that it incorporates a fluidizing pump 26 that can be used for fluidizing the media in other vessels. This is illustrated in FIG. 8. Since the fluidizing pump 26 only operates intermittently, it can be employed to fluidize the media in a number of separate vessels 12. This feature of the present invention enables the capital cost for media filters to be substantially reduced for a particular site that employs more than one media filter.

In FIG. 8, the fluidizing pump 26 is used to fluidize the media in four separate vessels. A short explanation of the system shown in FIG. 8 is in order. For example, if the desire is to clean the media (cleaning media mode) in the leftmost vessel, then fluidizing pump 26 is actuated and this causes the cleaning liquid to be drawn from the leftmost vessel through the fluidizing pump 26 into the media collector 100, 110 or 120. The media that is entrained in the cleaning liquid is captured in the media collector. During this mode of operation, the effluent from the media collector is directed to wastewater discharge. It is appreciated that certain valves would be incorporated into the system shown in FIG. 8 to isolate the leftmost vessel 12 and to discharge the cleaning liquid from the media collector as wastewater discharge. Once the media is cleaned, the various valves are reset to a media retrieval mode. Various valves in the system are set such that the cleaning liquid drawn from the leftmost vessel is again directed through the fluidizing pump 26 and through the media collector 100, 110 or 120 and back to the fluidizing nozzle in the leftmost vessel. Thus, in this mode the aim is to retrieve the media collected in the media collector. There is no wastewater discharge. In this mode of operation, the cleaning liquid passing through the media collector is returned (with the retrieved media) to the leftmost vessel 12 via the fluidizing nozzle.

The specification and claims use the term “configured”. “Configured”, as used herein, means “designed to”.

The present invention may, of course, be carried out in other specific ways than those herein set forth without departing from the scope and the essential characteristics of the invention. The present embodiments disclosed herein are therefore to be construed in all respects as illustrative and not restrictive and all changes coming within the meaning and equivalency range of the appended claims are intended to be embraced therein.

1-16. (canceled)

17. A cleaning process for cleaning contaminated media contained in a vessel used to filter a contaminated liquid stream, the cleaning process comprising:
directing a cleaning liquid into the vessel;
fluidizing the media in the vessel by employing a fluidizing pump that draws the cleaning liquid from the vessel, causing the cleaning liquid to move upwardly in the vessel, and returns the cleaning liquid to a fluidizing nozzle directed downwardly in the vessel;
wherein the fluidizing nozzle directs the cleaning liquid downwardly in a jet stream that creates turbulence in the vessel and cleans the media by contacting and agitating the media;
continuously fluidizing and agitating the media for a selected time period in the vessel and causing contaminants associated with the media to be separated therefrom and to become contained in the cleaning liquid;
confining substantially all of the media within the vessel during the cleaning process such that the cleaning process is carried out in the vessel;
discharging the cleaning liquid containing the contaminants separated from the media from the vessel;
collecting media entrained in the cleaning liquid being discharged and returning the collected media to the vessel, wherein the media is collected in a media collector disposed outside the vessel; and
wherein the media is collected by directing the cleaning liquid being discharged through the media collector; and wherein the collected media is retrieved and returned to the vessel by pumping the cleaning liquid from the vessel, through the media collector and back to the vessel.

18. The method of claim 17 wherein the media collector comprises a Y strainer, a double screen, or a hydrocyclone.

19. The method of claim 17 wherein the cleaning liquid being drawn from the vessel by the fluidizing pump is split into first and second streams, the first stream being directed to the fluidizing nozzle and the second stream being directed through a media collector which collects media entrained in the second stream.

20. The method of claim 19 wherein the media collected in the media collector is returned to the vessel by employing the fluidizing pump to pump the cleaning solution from the vessel through the media collector where the cleaning liquid picks up the collected media and returns the collected media to the vessel via the fluidizing nozzle.

21. The method of claim 17 wherein the vessel includes one or more baffle plates disposed in an upper portion of the vessel and projecting inwardly from a wall that forms a part of the vessel; and wherein the cleaning process includes inhibiting the upper movement of the fluidized media by contacting the fluidized media with the one or more baffle plates.

22. The cleaning process of claim 17 wherein there is provided two or more vessels containing media that are served by the fluidizing pump and the media collector.

23. The cleaning process of claim 18 wherein the media in the two or more vessels is cleaned sequentially where during each sequence of media cleaning, the cleaning liquid is pumped from at least one of the two or more vessels and wherein at least a portion of the cleaning liquid is directed through the media collector where the media is collected, and thereafter the cleaning liquid is directed through the media collector where the cleaning liquid retrieves the media and returns the media to the at least one vessel.

24. A cleaning process for cleaning contaminated media contained in a vessel used to filter a contaminated liquid stream comprising:
cleaning the media while confined in the vessel by:
a. directing a cleaning liquid into the vessel;
b. pumping the cleaning liquid from the vessel and splitting the cleaning liquid into a first stream and a second stream;
c. directing the first stream to a fluidizing nozzle directed downwardly in the vessel;
d. wherein the fluidizing nozzle discharges the first stream downwardly in a jet stream that contacts the media in the vessel, causing the cleaning liquid and the media to move upwardly through the vessel resulting in the media being fluidized in the vessel;
e. continuously fluidizing and agitating the media for a selected time period in the vessel and causing contaminants associated with the media to be separated therefrom and to become contained in the cleaning liquid;
f. confining most of the media within the vessel during the cleaning process such that the cleaning process is carried out in the vessel;
g. wherein the second stream contains contaminants separated from the media and some media;
h. directing the second stream into contact with the media collector and collecting media from the second stream in the media collector;
i. after collecting the media from the second stream, discharging the second stream containing the contaminants separated from the media; and
j. returning the media in the media collector to the vessel by pumping the cleaning liquid from the vessel, through the media collector and collecting the media with the cleaning liquid and returning the cleaning liquid and media to the vessel.

25. The method of claim 24 wherein the media collector is taken from the group consisting of a modified Y strainer, a double screen and a hydrocyclone.

26. The method of claim 24 wherein the vessel includes one or more baffle plates disposed in an upper portion of the vessel and projecting inwardly from a wall that forms a part of the vessel; and wherein the cleaning process includes inhibiting the upper movement of the fluidized media by contacting the fluidized media with the one or more baffle plates.

27. A media filter comprising:
a vessel for holding media;
an inlet associated with the vessel for directing liquid to be filtered into the vessel;
wherein the liquid to be filtered passes through the media and in the process is filtered;
an outlet associated with the vessel for discharging the filtered liquid;
a media cleaning system associated with the vessel and configured to clean the media comprising:
a. an inlet associated with the vessel and configured to receive a cleaning liquid;
b. a fluidizing pump configured to pump the cleaning liquid upwardly through the media and from the vessel;
c. a fluidizing nozzle disposed in the vessel and directed downwardly therein;
d. a fluidizing line disposed external of the vessel and operatively connected to the fluidizing pump and the fluidizing nozzle and configured to channel cleaning liquid from the vessel to the fluidizing nozzle;
e. the fluidizing nozzle configured to discharge cleaning liquid downwardly in a jet stream, creating turbulence in the vessel, and cleaning the media by contacting and agitating the media and causing the cleaning liquid and the media to move upwardly through the vessel where the media becomes fluidized in the vessel;
f. a wastewater discharge line that branches from the fluidizing line and configured to direct a portion of the cleaning liquid to a discharge point;
g. a media collector disposed in a wastewater discharge line and configured to collect media entrained in the cleaning liquid passing through the wastewater discharge line; and
h. a media return line operatively associated with the media collector and the fluidizing pump, wherein the fluidizing pump is configured to pump cleaning liquid from the vessel through the media collector where the cleaning liquid picks up media collected by the media collector and return the cleaning liquid and the collected media through the media return line to the vessel.

28. A media filter comprising:
a vessel configured to hold media used to filter a liquid;
a media cleaning system including:
a. an inlet associated with the vessel for directing a cleaning liquid into the vessel;
b. a fluidizing pump associated with the vessel;
c. a fluidizing nozzle disposed in the vessel for fluidizing the media;
d. a media collector disposed outside of the vessel and configured to collect the media;
e. a piping network operatively connected to the vessel, the fluidizing pump, the fluidizing nozzle and the media collector;
f. wherein the media cleaning system is configured to operate in first and second modes;
g. in said first mode, the fluidizing pump is configured to:
1. pump a first portion of the cleaning liquid from the vessel to the fluidizing nozzle which fluidizes, agitates and cleans the media,
2. pump a second portion of the cleaning liquid through the media collector where the media entrained in the cleaning liquid is collected, and
3. pump a resulting wastewater downstream of the media collector to a discharge point; and
h. in said second mode, the fluidizing pump is configured to pump the cleaning liquid from the vessel through the media collector where the cleaning liquid collects the media therein and returns the media to the vessel.

29. The media filter of claim 28 wherein the media collector comprises a Y strainer, double screen or hydrocyclone.

30. The media filter of claim 28 wherein the media collector is configured to permit the cleaning liquid to flow therethrough and is further configured to cause media entrained in the cleaning liquid to be separated from the cleaning liquid and to collect in a collection area forming a part of the media collector.
